(19) United States
(12) Patent Application Publication
(10) Pub. No.: US 2021/0323345 A1
(43) Pub. Date: Oct. 21, 2021

(54) WOOD LAMINATED CONSTRUCTION ELEMENT

(71) Applicant: MIN-JU CHUNG, TAICHUNG CITY (TW)

(72) Inventor: MIN-JU CHUNG, TAICHUNG CITY (TW)

(21) Appl. No.: 16/853,127

(22) Filed: Apr. 20, 2020

(51) Int. Cl. B44F 9/02; B27M 3/00; B44C 5/04

(52) U.S. Cl. CPC B44F 9/02; B27M 3/0026; B27M 3/18; B44C 5/0469; B44C 5/043

(57) ABSTRACT

A wood laminated construction element includes a wooden surface piece and a wooden bonded body. The wooden surface piece has a natural wood grain in a first wood grain direction, and includes two end segments and a connection segment disposed between the end segments. The wooden bonded body includes at least an end wood piece and at least a connection wood piece. The end wood piece is adhered to one of the end segments, and has a natural wood grain in a second wood grain direction transverse to the first wood grain direction. The connection wood piece is adhered at least to the connection segment, and has a natural wood grain in a third wood grain direction which is consistent with the first wood grain direction.

### FIELD

The disclosure relates to a construction element, more particularly to a wood laminated construction element.

### BACKGROUND

In order to save on manufacturing cost, when making furniture, logs of different qualities may be used to form a wood laminate having a wooden surface piece and a wooden body piece. Normally, the wooden surface piece is cut from a relatively expensive log to permit the wood laminate to have a good appearance, and the wooden body piece is cut from a relatively cheap log to serve as a main structure of the wood laminate.

When the wood laminate is subjected to heat, the wooden surface piece and the wooden body piece with different coefficients of thermal expansion are likely to delaminate from each other. To prevent delamination due to thermal expansion, the wooden surface piece and the wooden body piece are usually adhered to each other with their wood grain directions consistent with each other.

However, a period of time after use, two end portions of the wood laminate, which are opposite to each other in the wood grain directions, may have a crack in the wood grain directions. The crack may also cause the delamination of the wood laminate.

### SUMMARY

Therefore, an object of the disclosure is to provide a wood laminated construction element which is more durable.

According to the disclosure, a wood laminated construction element includes a wooden surface piece and a wooden bonded body. The wooden surface piece has a natural wood grain in a first wood grain direction, and includes a pair of end segments which are opposite to each other in the first wood grain direction, and a connection segment disposed between the end segments. The wooden bonded body includes at least an end wood piece and at least a connection wood piece. The end wood piece is adhered to one of the end segments, and has a natural wood grain in a second wood grain direction which is transverse to the first wood grain direction. The connection wood piece is adhered at least to the connection segment, and has a natural wood grain in a third wood grain direction which is consistent with the first wood grain direction.

Because the natural wood grain of the end wood piece of the wooden bonded body is arranged transverse to the natural wood grain of the wooden surface piece, an end portion of the wood laminated construction element, which has a juncture of the end wood piece and the wooden surface piece, is less likely to crack along the natural wood grains. Therefore, the wood laminated construction element of the disclosure is more durable than a conventional one.

### BRIEF DESCRIPTION OF THE DRAWINGS

Other features and advantages of the disclosure will become apparent in the following detailed description of the embodiment(s) with reference to the accompanying drawings, in which:

FIG. 1 is a perspective view of a wood laminated construction element according to a first embodiment of the disclosure;

FIG. 2 is a partially exploded perspective view of the first embodiment;

FIG. 3 is a top view of a wooden surface piece of the first embodiment;

FIG. 4 is a top view of a wooden bonded body of the first embodiment;

FIG. 5 is a partially exploded perspective view of a wood laminated construction element according to a second embodiment of the disclosure; and

FIG. 6 is a top view of a wooden bonded body of the second embodiment.

### DETAILED DESCRIPTION

Before the disclosure is described in greater detail, it should be noted that where considered appropriate, reference numerals have been repeated among the figures to indicate corresponding or analogous elements, which may optionally have similar characteristics.

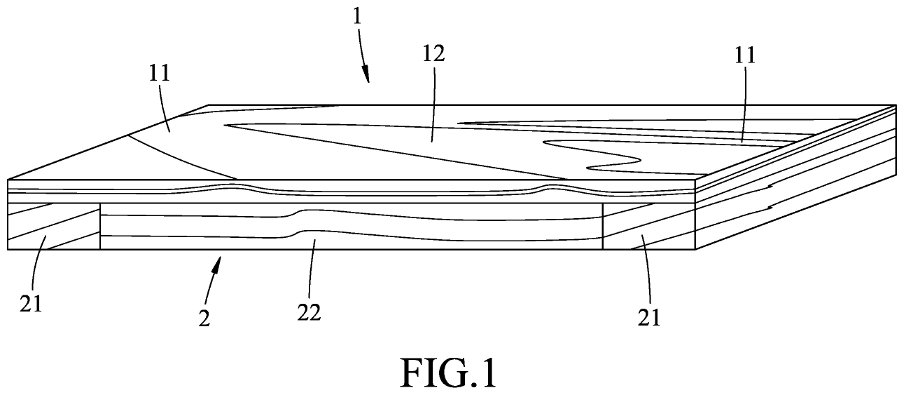

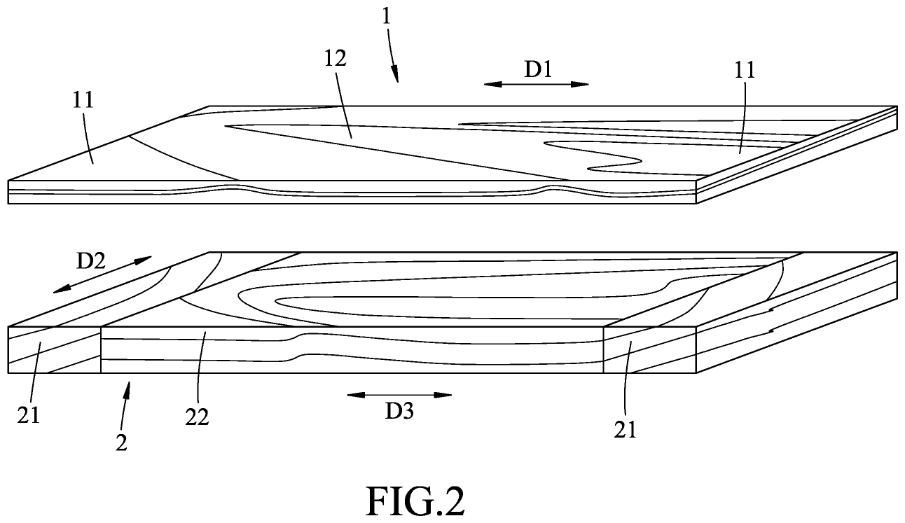

Referring to FIGS. 1 and 2, a wood laminated construction element according to a first embodiment of the disclosure is shown to include a wooden surface piece 1 and a wooden bonded body 2.

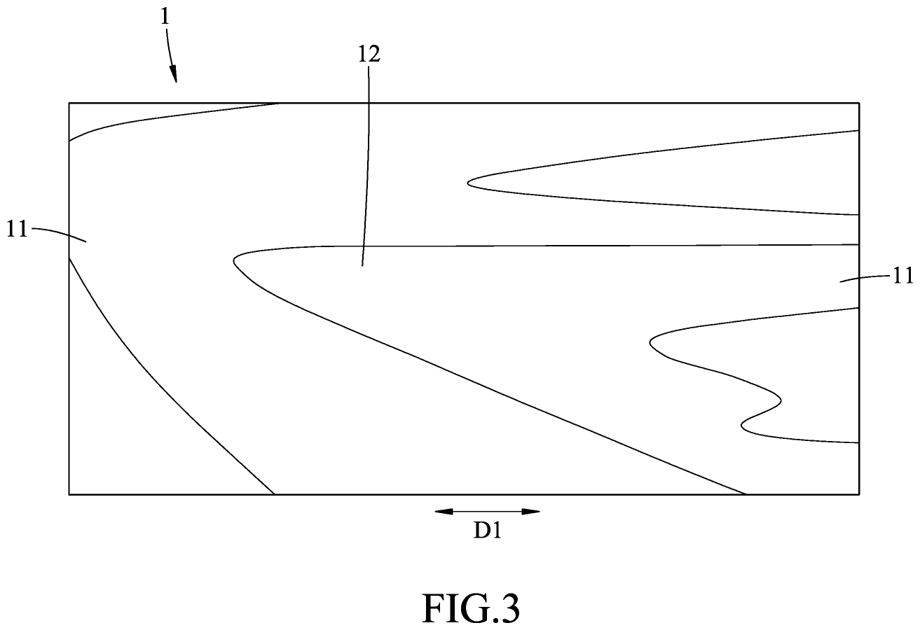

As shown in FIGS. 2 and 3, the wooden surface piece 1 has a natural wood grain in a first wood grain direction (D1), and includes a pair of end segments 11 which are opposite to each other in the first wood grain direction (D1), and a connection segment 12 disposed between the end segments 11.

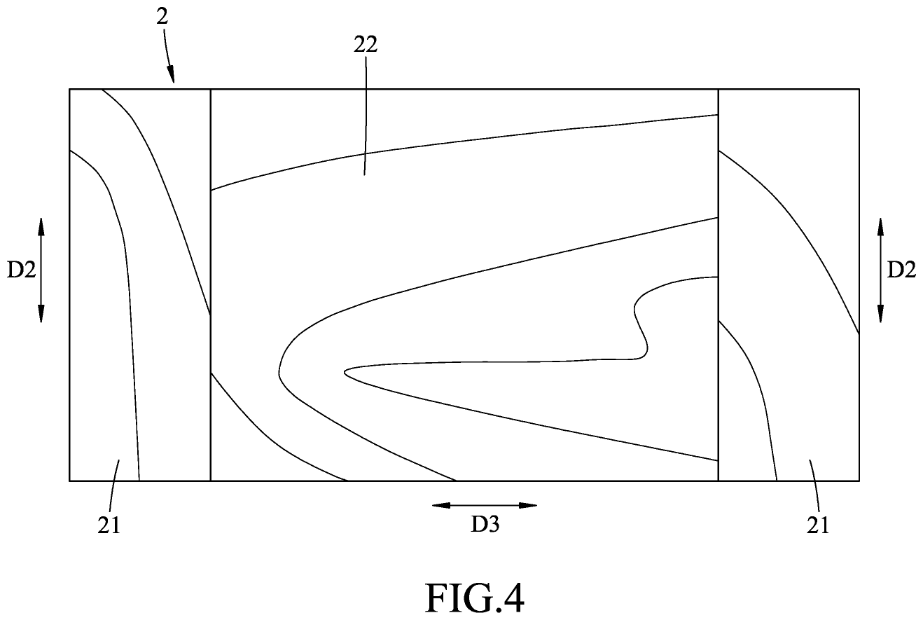

As shown in FIGS. 1, 2 and 4, the wooden bonded body 2 includes two end wood pieces 21 and a connection wood piece 22. The end wood pieces 21 are adhered to the end segments 11, respectively. Each of the end wood pieces 21 has a natural wood grain in a second wood grain direction (D2) which is transverse to the first wood grain direction (D1). The connection wood piece 22 is adhered to the connection segment 12, and has a natural wood grain in a third wood grain direction (D3) which is consistent with the first wood grain direction (D1).

In an embodiment shown in FIG. 2, the second wood grain direction (D2) is perpendicular to the first wood grain direction (D1).

In an embodiment shown in FIGS. 1 to 3, the wooden surface piece 1 has a substantially rectangular shape and is elongated in the first wood grain direction (D1).

In an embodiment shown in FIGS. 1, 2, and 4, each of the end wood pieces 21 has a substantially rectangular shape and is elongated in the second wood grain direction (D2). In other embodiment, each of the end wood pieces 21 may have a shape other than a rectangular shape.

In an embodiment shown in FIGS. 1 to 4, the wooden surface piece 1 and the wooden bonded body 2 both have rectangular shapes of the same dimension in a plane view, and are both in plank forms. The wooden bonded body 2 has a larger thickness than the wooden surface piece 1. In other embodiments, each of the wooden surface piece 1 and the wooden bonded body 2 may have a shape other than the rectangular shape.

Please note that because a bonding area between the wooden surface piece 1 and the connection wood piece 22 is much larger than a total bonding area among the wooden surface piece 1 and the end wood pieces 21, and because the third wood grain direction (D3) is consistent with the first wood grain direction (D1), the wood laminated construction element is less likely to delaminate due to thermal expansion. In addition, because the end wood pieces 21 are respectively adhered to the end segments 11 of the wooden surface piece 1, and because the second wood grain direction (D2) is transverse to the first wood grain direction (D1), the end segments 11 of the wooden surface piece 1 are less likely to crack in the first wood grain direction (D1) along the natural wood grain. Therefore, the wood laminated construction element is durable. Also, the wooden surface piece 1 is a single wood piece and may provide a good appearance.

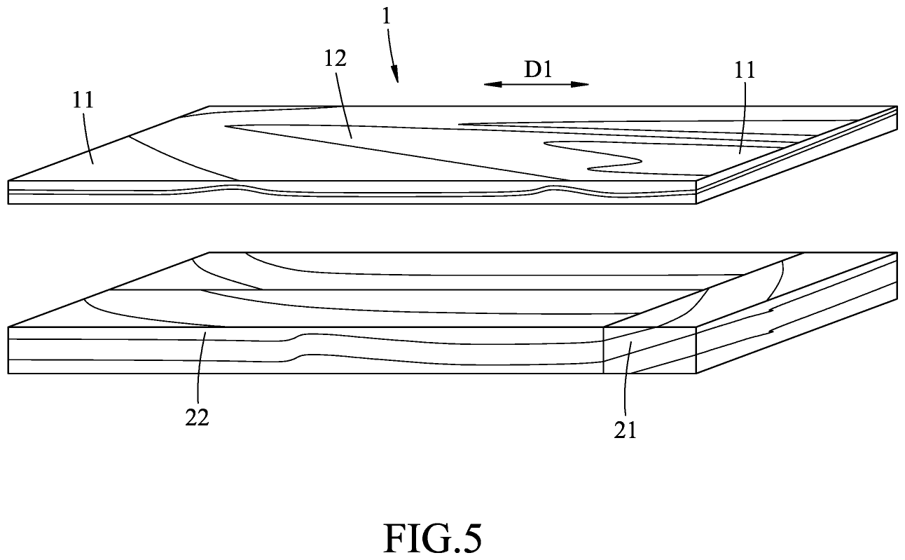

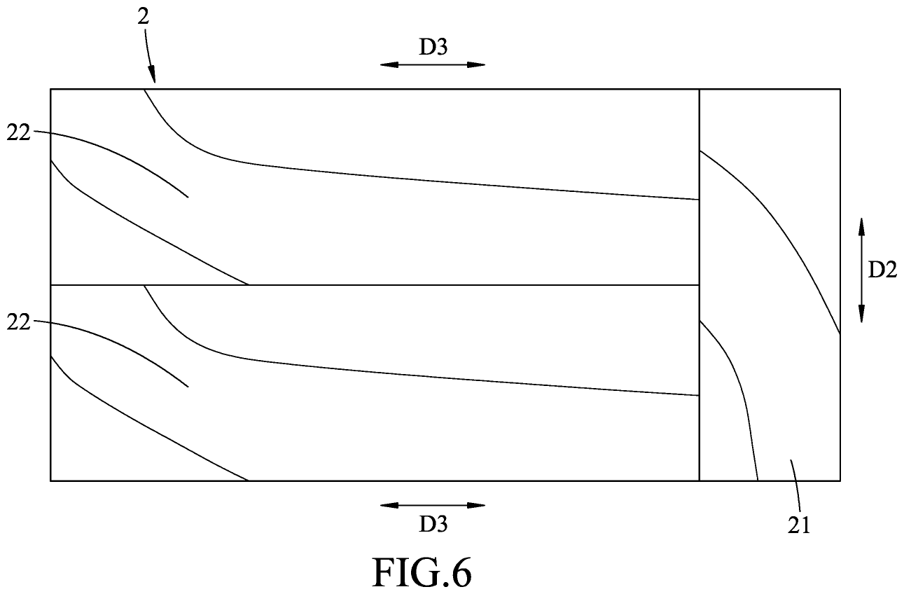

FIGS. 5 and 6 illustrate a wood laminated construction element according to a second embodiment of the disclosure. The second embodiment is similar to the first embodiment except that in the second embodiment, the wooden bonded body 2 includes only one of the end wood pieces 21 which is adhered to one of the end segments 11, and two of the connection wood pieces each of which is adhered to both the connection segment 12 and the other one of the end segments 11.

The second embodiment may also achieve the effects achieved in the first embodiment, and exemplifies that the number of the end wood piece 21 and the connection wood piece 22 may be varied based on requirement. The number of the number of the end wood piece 21 or the connection wood piece 22 may be one, two, three or more based on the design requirement especially when each of the wooden surface piece 1 and the wooden bonded body 2 is not a rectangular shape.

In sum, because the natural wood grain of at least one end wood piece 21 of the wooden bonded body 2 is arranged transverse to the natural wood grain of the wooden surface piece 1, an end portion of the wood laminated construction element, which has a juncture of the end wood piece 21 and the wooden surface piece 1, is less likely to crack along the natural wood grains. Therefore, the wood laminated construction element of the disclosure is more durable than a conventional one.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment (s), it is understood that this disclosure is not limited to the disclosed embodiment(s) but is intended to cover various arrangements included within the spirit and scope of the broadest interpretation so as to encompass all such modifications and equivalent

What is claimed is:

1. A wood laminated construction element comprising:
a wooden surface piece having a natural wood grain in a first wood grain direction, and including a pair of end segments which are opposite to each other in the first wood grain direction, and a connection segment disposed between said end segments; and
a wooden bonded body including
at least an end wood piece adhered to one of said end segments, and having a natural wood grain in a second wood grain direction which is transverse to the first wood grain direction, and
at least a connection wood piece adhered at least to said connection segment, and having a natural wood grain in a third wood grain direction which is consistent with the first wood grain direction.

2. The wood laminated construction element according to claim 1, wherein the second wood grain direction is perpendicular to the first wood grain direction.

3. The wood laminated construction element according to claim 1, wherein said wooden bonded body includes two of the end wood pieces which are adhered to said end segments, respectively.

4. The wood laminated construction element according to claim 2, wherein said wooden surface piece has a substantially rectangular shape and is elongated in the first wood grain direction.

5. The wood laminated construction element according to claim 4, wherein said end wood piece has a substantially rectangular shape and is elongated in the second wood grain direction.

6. The wood laminated construction element according to claim 1, wherein said wooden bonded body has a larger thickness than said wooden surface piece.
